(19) United States
(12) Patent Application Publication
(10) Pub. No.: US 2018/0327284 A1
(43) Pub. Date: Nov. 15, 2018

(54) WASHING MACHINE RINSE WATER PURIFICATION DEVICE AND WASHING APPARATUS

(71) Applicant: Panasonic Intellectual Property Management Co., Ltd., Osaka (JP)

(72) Inventors: GAKU MIYAKE, Osaka (JP); GENICHIRO MATSUDA, Nara (JP); TAKAHIRO KITAI, Hyogo (JP); YOSHIO YAMADA, Hyogo (JP)

(21) Appl. No.: 15/950,816

(22) Filed: Apr. 11, 2018

(30) Foreign Application Priority Data
May 11, 2017 (JP) 2017-094946

(51) Int. Cl. C02F 1/46; C02F 1/72; D06F 35/00

(52) U.S. Cl. CPC C02F 1/4608; C02F 1/722; C02F 2307/12; C02F 2303/04; C02F 2305/023; D06F 35/003

(57) ABSTRACT

A washing machine rinse water purification device and washing apparatus including the washing machine rinse water purification device. The washing machine rinse water purification device includes a first liquid supplier, a processing tub, a buffer tub and a washing tub. In the first liquid supplier, a first liquid introduced from an introduction portion into a processing tub is swirled from an introduction portion to a discharge portion to generate a swirling flow, plasma is generated in a gas phase to produce a reforming component, the produced reforming component is dissolved in the first liquid and is dispersed in the first liquid to produce a reforming liquid, the produced reforming liquid temporarily passes through a buffer tub from a discharge portion and then is supplied into a washing tub as a second liquid.

### TECHNICAL FIELD

The technical field relates to a washing machine rinse water purification device and a washing apparatus for sterilizing water for washing (washing rinse water, washing water, or tub washing water of a washing tub) to be used in a washing machine by a liquid processing apparatus for electrochemically processing a liquid.

### BACKGROUND

FIG. 15 illustrates an example of a reforming liquid producing device of the related art. A reforming liquid producing device, in which first electrode 801 and second electrode 802 are disposed in liquid 803 (for example, water), a high voltage pulse is applied between both electrodes 801 and 802 from pulse power supply 804 to evaporate liquid 803 and generate plasma 805, thereby producing a reforming liquid containing a component having, for example, oxidizing power such as a hydroxyl radical (OH radical) or hydrogen peroxide, is known. Particularly, it is known that the OH radical has high oxidizing power and a high sterilizing action with respect to, for example, bacteria. The reforming liquid will thus also have high oxidizing power and a high sterilizing action when it contains components with the OH radical. In addition, it is known that when plasma 805 is covered by liquid 803, a liquid-derived component is easily generated by generating plasma 805 in liquid 803. For example, it is known that the OH radical or hydrogen peroxide is easily produced by generating plasma 805 in water.

However, in a case of the reforming liquid producing device of the related art, not only is a high applying voltage required for evaporating liquid 803 but also the generation efficiency of plasma 805 is low. There is also a problem in that it takes a long period of time to reform liquid 803.

Therefore, a reforming liquid producing device, in which gas introduced from an outside is interposed between both electrodes to improve the generation efficiency of plasma while lowering the applying voltage, is known (see Japanese Patent No. 4041224). In the reforming liquid producing device (FIG. 16) disclosed in Japanese Patent No. 4041224, gas 904 (for example, oxygen) is interposed between anode electrode 901 and cathode electrode 902 together with processed liquid 903, and a pulse voltage is applied between both electrodes 901 and 902. Plasma is generated in gas 904 and reformation of processed liquid 903 is generated on a contact surface between the plasma and the processed liquid 903 by applying the pulse voltage. According to the reforming liquid producing device disclosed in Japanese Patent No. 4041224, it is possible to reduce the applying voltage and to perform reformation of processed liquid 903 by efficiently generating plasma as compared to a case where gas is not interposed.

As disclosed in Japanese Patent No. 5884065, an application to a washing machine rinse water purification device having a function of sterilizing water by introducing such a processed liquid as the rinse water of the washing machine is considered.

### SUMMARY

However, in a case where the reforming liquid producing device disclosed in Japanese Patent No. 4041224 or the reforming liquid producing device disclosed in Japanese Patent No. 5884065 is applied to rinse water of a washing machine, there is a problem that the generation efficiency of plasma is low, it takes a long period of time for processing the rinse water, and the sterilizing ability of the rinse water is insufficient.

An object of the disclosure is to provide a washing machine rinse water purification device and a washing apparatus in which water for washing such as rinse water, washing water, or tub washing water of a washing tub can be rapidly reformed by efficiently generating plasma, so that a processing time of the water for washing can be shortened and there is no shortage of sterilizing ability.

According to an aspect of the disclosure, there is provided a washing machine rinse water purification device including: a processing tub that generates a gas phase in the vicinity of a swirling center of a swirling flow of a first liquid by swirling the first liquid introduced from an introduction portion around a center axis and includes a discharge portion that discharges the first liquid; a buffer tub that includes a buffer chamber which temporarily stores the first liquid discharged from the discharge portion of the processing tub and a reforming liquid discharge port of the buffer chamber connectable to a rinse port of a washing tub at a position higher than the discharge portion, and supplies the first liquid temporarily stored in the buffer chamber from the reforming liquid discharge port to the rinse port of the washing tub as a second liquid to be used in the washing tub; a first liquid supplier that introduces the first liquid from the introduction portion into the processing tub; a first electrode of which at least a part is disposed in the processing tub on one end side along the center axis of the processing tub; a second electrode that is disposed so as to come into contact with the first liquid in the processing tub on the other end side along the center axis of the processing tub; and a power supply that generates plasma in the gas phase by applying a voltage between the first electrode and the second electrode. In the first liquid supplier, the first liquid introduced from the introduction portion into the processing tub is swirled between the introduction portion and the discharge portion to generate the swirling flow, the plasma is generated in the gas phase to produce a reforming component, the produced reforming component is dissolved in the first liquid and is dispersed in the first liquid to produce a reforming liquid, and the produced reforming liquid temporarily passes through the buffer tub from the discharge portion and then is supplied into the washing tub as the second liquid.

According to another aspect of the disclosure, there is provided a washing apparatus including: the washing machine rinse water purification device according to the above-described aspect; and the washing tub to which the reforming liquid generated in the washing machine rinse water purification device is supplied from the buffer tub via the rinse port as the second liquid.

According to the washing machine rinse water purification device and the washing apparatus of the above-described aspects, the water for washing of the first liquid introduced via the introduction portion is swirled between the introduction portion and the discharge portion to generate the swirling flow, the plasma is generated in the gas phase generated in the swirling flow of the water for washing to produce the reforming component, the produced reforming component is dissolved in the water for washing and is dispersed in the water for washing to produce the reforming liquid. The produced reforming liquid is supplied from the discharge portion into the water for washing in the buffer tub and sterilizes the water for washing in the buffer tub so that the water for washing can be efficiently sterilized. Here, the water for washing in the swirling flow is evaporated and a pulse voltage is applied to the generated gas phase to generate plasma. Since it is unnecessary to evaporate the water for washing in the swirling flow by Joule heat, plasma can be generated and reformation of the water for washing can be performed efficiently and rapidly with less electric power. That is, plasma is efficiently generated to rapidly reform the water for washing, so that a processing time of the water for washing can be shortened.

### BRIEF DESCRIPTION OF THE DRAWINGS

FIG. 1 is a side sectional view illustrating a configuration of a reforming liquid producing device that is a washing machine rinse water purification device according to Embodiment 1 of the disclosure.

FIG. 2 is a side sectional view of a device body of the reforming liquid producing device.

FIG. 3 is a sectional view which is taken along line 3-3 of FIG. 2.

FIG. 4 is a side sectional view illustrating a state where a swirling flow is generated on an inside of a processing tub and a voltage is not applied.

FIG. 5 is a sectional view which is taken along line 5-5 of FIG. 4.

FIG. 6A is a side sectional view illustrating a state where the swirling flow is generated on the inside of the processing tub and a voltage is applied.

FIG. 6B is a partial enlarged view of a state where plasma is generated in a gas phase of FIG. 6A.

FIG. 6C is a side sectional view of a state where the washing machine rinse water purification device is disposed adjacent to the washing tub and washing water is sterilized.

FIG. 6D is a side sectional view of an entire washing apparatus.

FIG. 7 is a side sectional view illustrating a modification example of a device body.

FIG. 8 is a side sectional view illustrating a modification example of a device body.

FIG. 9A is a side sectional view illustrating a modification example of a device body.

FIG. 9B is a side sectional view illustrating a modification example of a device body different from that of FIG. 9A.

FIG. 10 is a side sectional view illustrating a modification example of a device body.

FIG. 11 is a side sectional view illustrating a modification example of a device body.

FIG. 12 is a side sectional view illustrating a modification example of a device body.

FIG. 13 is a side sectional view illustrating a modification example of a device body.

FIG. 14A is a side sectional view illustrating a modification example of a device body.

FIG. 14B is a side sectional view in which a copper material is disposed in a part of a buffer tub in a modification example of a device body.

FIG. 15 is a schematic configuration view of a reforming liquid producing device of the related art.

FIG. 16 is a schematic configuration view of the reforming liquid producing device of the related art including a gas introducing device.

### DESCRIPTION OF EMBODIMENTS

### Embodiment 1

Hereinafter, reforming liquid producing device 100 that is a washing machine rinse water purification device according to Embodiment 1 of the disclosure will be described in detail with reference to the drawings. The same reference numerals are given to the same portion or corresponding portions in the drawings and description thereof will not be repeated. In order to make the explanation easy to understand, in the drawings referred to below, a configuration is simplified or schematically illustrated, and some constituent members are omitted. In addition, a dimensional ratio between the constituent members shown in each drawing does not necessarily indicate the actual size ratio.

### Entire Configuration

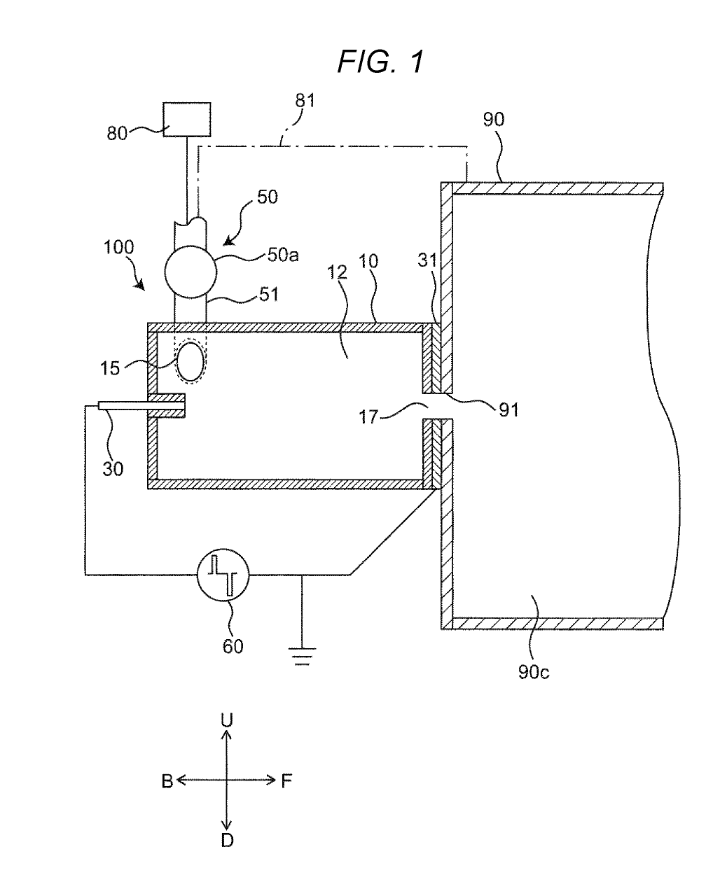

First, an entire configuration of reforming liquid producing device 100 according to Embodiment 1 will be described. FIG. 1 is a side sectional view illustrating a configuration of reforming liquid producing device 100 according to Embodiment 1 of the disclosure. In the following drawings, arrow F indicates a forward direction and arrow B indicates a backward direction of reforming liquid producing device 100. Arrow U indicates an upward direction and arrow D indicates a downward direction. Arrow R indicates a rightward direction as viewed from the backward direction and arrow L indicates a leftward direction as viewed from the backward direction.

Reforming liquid producing device 100 produces a reforming component by discharging in a liquid and produces a reforming liquid by dispersing the reforming component in the liquid. In Embodiment 1, a case where processed water L1 as a first liquid is reformed and reforming liquid L2 containing a reforming component such as an OH radical or hydrogen peroxide is produced will be described. Here, processed water L1 means a liquid that is supplied from a liquid supply source (for example, water tank 80 or a bathtub of a bath) to processing tub 12 via pump 50a and valve 112 through pipe 51, a liquid that is supplied from a liquid supply source (for example, tap water) to processing tub 12 via valve 112 through pipe 51, or a liquid that is washing water 92 held in buffer tub 90, which is supplied to processing tub 12 in liquid supplier 50 such as pump 50a through circulation pipe 81 and pipe 51. In the present specification, the washing water means a washing rinse water (water or hot water) used for rinsing in a washing tub, a washing water (water or hot water) used for washing by putting detergent in a washing tub, or a tub washing water of the washing tub.

Reforming liquid producing device 100 includes at least processing tub 12, first electrode 30, second electrode 31, and power supply 60. More specifically, reforming liquid producing device 100 includes device body 10, liquid supplier 50, buffer tub 90 as an example of a storage tub, and power supply 60. Device body 10 includes processing tub 12, introduction portion 15, discharge portion 17, first electrode 30, and second electrode 31.

Processing tub 12 is a portion that produces the reforming component by plasma with processed water L1 introduced inside. A material of processing tub 12 may be an insulator or a conductor. In a case of the conductor, it is necessary to interpose an insulator between electrodes 30 and 31. When the reforming component is discharged to buffer tub 90, the reforming component is dispersed in processed water L1 and reforming liquid L2 is produced.

Processing tub 12 includes a columnar processing chamber having a circular front sectional shape. Introduction portion 15 is disposed at one end of processing tub 12 to introduce processed water L1 into processing tub 12 from a tangential direction of a circular sectional shape orthogonal to center axis X1 of processing tub 12. Introduction portion 15 communicates with liquid supplier 50 via pipe 51. Discharge portion 17 is disposed at the other end of processing tub 12 to discharge processed water L1 introduced into processing tub 12 and the reforming component produced in processing tub 12 from processing tub 12 to buffer tub 90. In Embodiment 1, discharge portion 17 is connected to intake port 91 of buffer tub 90.

First electrode 30 is disposed inside at one end of processing tub 12. First electrode 30 protrudes from a center of an inner wall at one end of processing tub 12 into processing tub 12 along a longitudinal direction.

Second electrode 31 is disposed outside the wall at the other end of processing tub 12 to be disposed in the vicinity of discharge portion 17.

First electrode 30 is connected to power supply 60 and second electrode 31 is grounded. A pulse voltage of a high voltage is applied to first electrode 30 and second electrode 31 by power supply 60. As a material of first electrode 30, for example, tungsten is used.

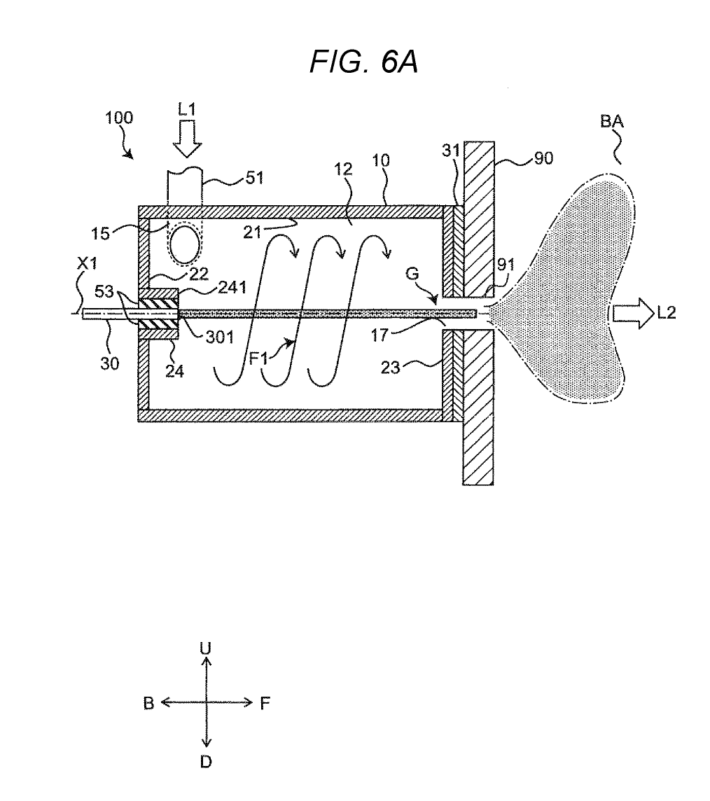

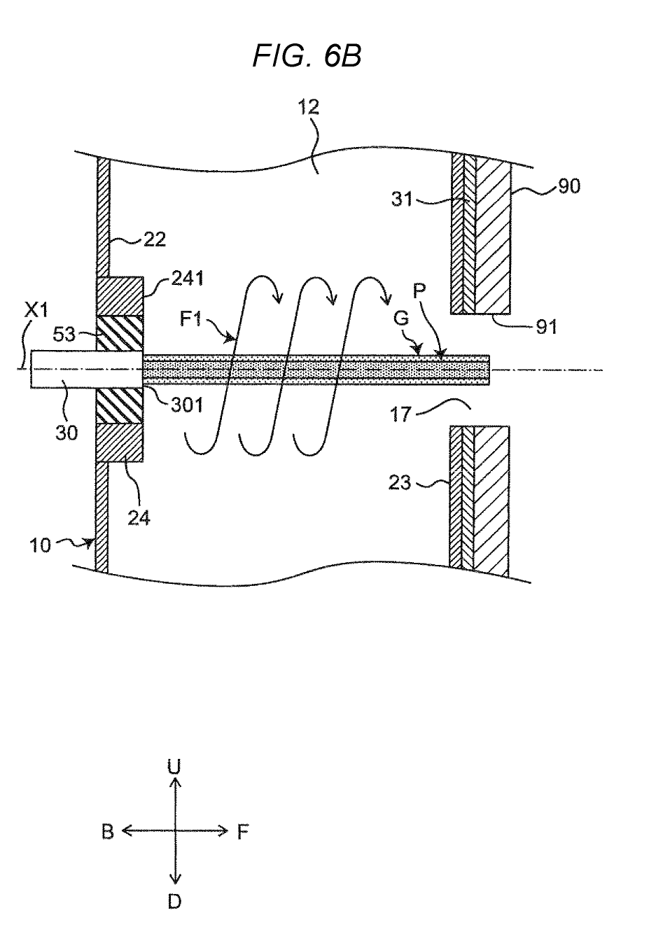

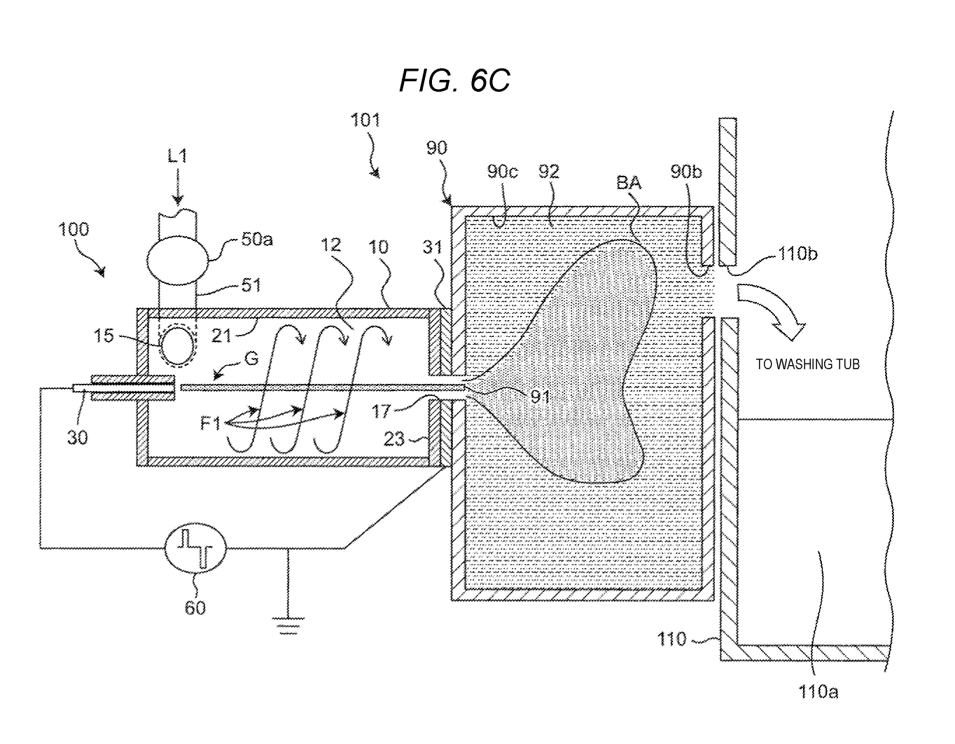

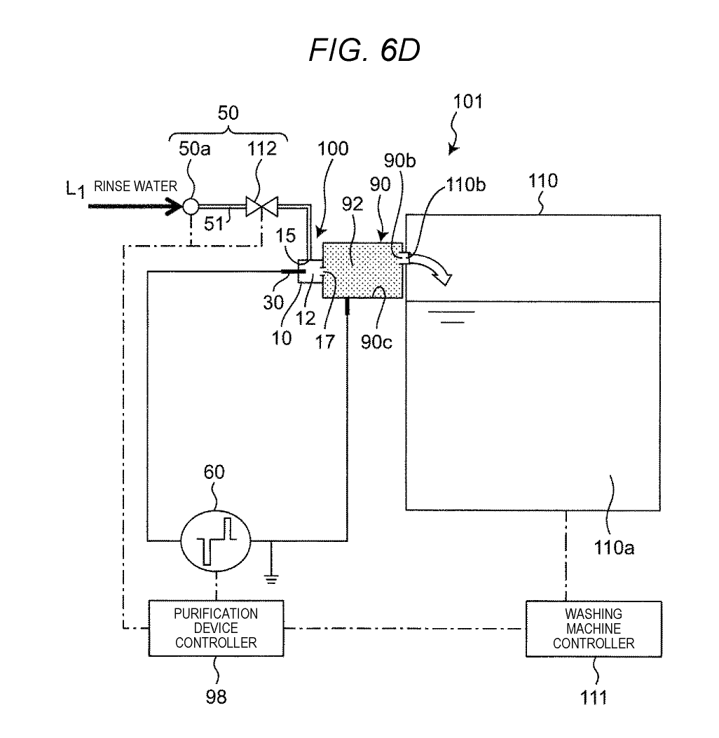

Liquid supplier 50 is configured of pump 50a and valve 112 (see FIG. 6D), or valve 112 for supplying processed water L1 into processing tub 12. Liquid supplier 50 is connected to pipe 51. One end of pipe 51 is connected to introduction portion 15 as an inside opening in the vicinity of the inner wall of one end of processing tub 12 and the other end of pipe 51 is connected to the liquid supply source (not illustrated) (for example, water tank 80) or in a form in which storage water containing the reforming liquid of buffer tub 90 can be circulated.

Power supply 60 applies the pulse voltage of a high voltage between first electrode 30 and second electrode 31. Power supply 60 can apply a so-called bipolar pulse voltage that alternately applies a positive pulse voltage and a negative pulse voltage.

Buffer tub 90 is a tub for shearing the reforming component discharged from reforming liquid producing device 100, producing micro-bubbles or nano-bubbles containing the reforming component, and diffusing the micro-bubbles or nano-bubbles in water. Specifically, buffer tub 90 includes therein buffer chamber 90c having a cross-sectional area larger than a cross-sectional area of the opening of discharge portion 17 of processing tub 12. The reforming component discharged from discharge portion 17 into buffer chamber 90c is sheared in buffer chamber 90c. Micro-bubbles or the micro-bubbles and nano-bubbles containing the reforming component are produced in buffer chamber 90c. The produced micro-bubbles or the micro-bubbles and nano-bubbles are diffused in water. Therefore, buffer tub 90 functions as a micro-bubble producing tub. A reforming liquid reliably performing sterilization can be produced in buffer tub 90 by securing an inner diameter or one side that is at least twice an inner diameter dimension of the opening of discharge portion 17 of processing tub 12.

Buffer chamber 90c includes intake port 91 of buffer tub 90 connected to discharge portion 17 of processing tub 12. Reforming liquid discharge port 90b of buffer tub 90 is disposed above discharge portion 17 and intake port 91. Reforming liquid discharge port 90b is connectable to rinse port 110b of washing tub 110. Therefore, the produced reforming liquid is supplied from reforming liquid discharge port 90b into washing tub 110 through rinse port 110b of washing tub 110. The reason for disposing reforming liquid discharge port 90b above discharge portion 17 and intake port 91 is as follows. If reforming liquid discharge port 90b is disposed below discharge portion 17 and intake port 91, air entering from reforming liquid discharge port 90b enters processing tub 12 through discharge portion 17, idle discharge with no processed water L1 is generated in processing tub 12, and there is a possibility that the reforming liquid producing device 100 cannot perform the desired operation. In addition, it is also necessary to prevent a load on electrodes 30 and 31, and power supply 60 due to the idle discharge. Therefore, it is necessary to dispose reforming liquid discharge port 90b above discharge portion 17 and intake port 91.

### Device Body

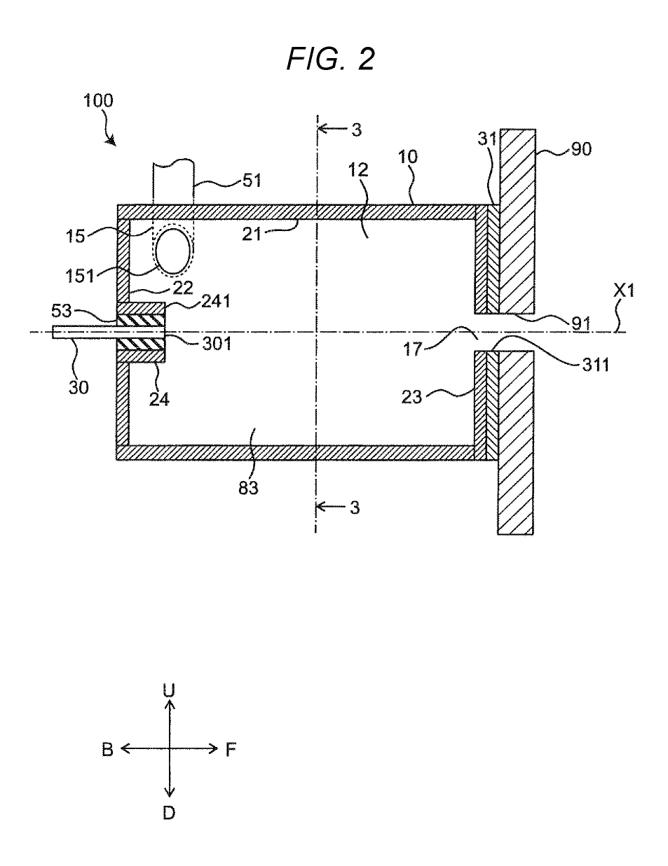

Next, device body 10 will be described in detail. FIG. 2 is a side sectional view of device body 10.

Processing tub 12 includes first inner wall 21, second inner wall 22, and third inner wall 23. First inner wall 21 is a cylindrical wall portion. Second inner wall 22 is provided at a left end portion of first inner wall 21 in FIG. 2. Third inner wall 23 is provided at a right end portion of first inner wall 21 in FIG. 2. Second inner wall 22 and third inner wall 23 have substantially a circular shape in a side view. Substantially columnar accommodating space 83 is configured inside processing tub 12 by first inner wall 21, second inner wall 22, and third inner wall 23. A center axis of first inner wall 21, that is, a virtual center axis of substantially columnar accommodating space 83 configuring the inside of processing tub 12 is referred to as center axis X1.

In second inner wall 22, cylindrical electrode support tube 24 protruding into accommodating space 83 is provided at a center. Electrode support tube 24 is cylindrical and extends in the rightward direction. Electrode support tube 24 is disposed so that a center axis thereof matches center axis X1. First electrode 30 is supported on the inside of electrode support tube 24 via insulator 53. First electrode 30 has a rod shape and insulator 53 is disposed around first electrode 30. First electrode 30 is disposed so that an axis thereof in the longitudinal direction matches center axis X1. An inside end surface of right end portion 301 of first electrode 30, an inside end surface of insulator 53, and inside end surface 241 of electrode support tube 24 are configured so as to be disposed substantially in the same plane.

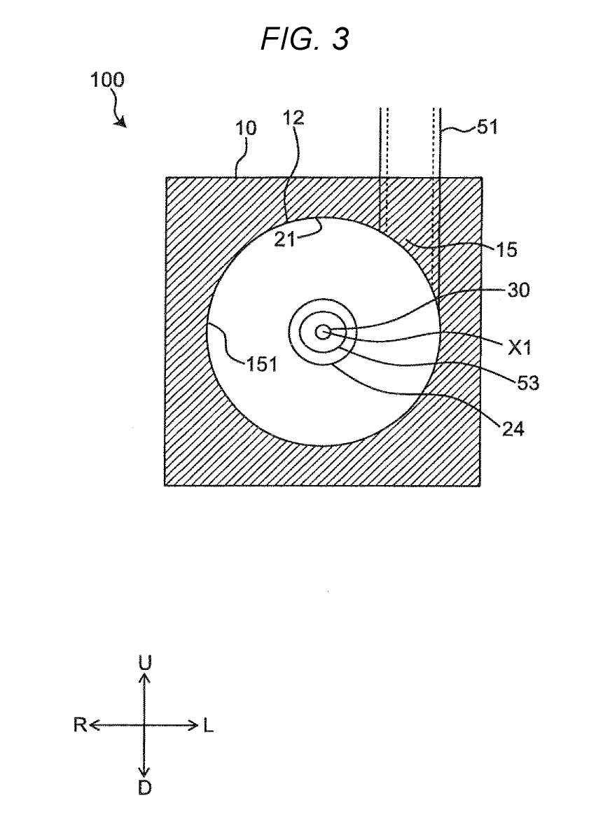

Introduction portion 15 penetrates device body 10 and one opening end 151 is formed on first inner wall 21. Introduction portion 15 is disposed at a position adjacent to second inner wall 22 in a side view. In addition, FIG. 3 is a sectional view which is taken along line 3-3 of FIG. 2. Introduction portion 15 is disposed on the wall surface of first inner wall 21.

Discharge portion 17 penetrates a center portion of third inner wall 23. Discharge portion 17 is formed so that a center axis thereof matches center axis X1.

Second electrode 31 is a plate-like metal member and opening 311 is formed at the center portion. Opening 311 has a circular shape and is formed so that a center axis thereof matches center axis X1.

Purification device controller 98 controls valve 112 and power supply 60 independently. If pump 50a is disposed, driving of pump 50a is controlled by purification device controller 98. For the timing of driving of the pump 50a, for example, when valve 112 is opened, pump 50a is driven and when valve 112 is closed, driving of pump 50a is stopped. When a washing rinse water introducing signal is received from washing machine controller 111 of washing tub 110, purification device controller 98 opens valve 112 and turns on power supply 60 to produce the reforming liquid. Washing machine controller 111 of washing tub 110 inputs the washing rinse water introducing signal into purification device controller 98 when it becomes a rinsing step, that is, a washing rinse water introducing period in a series of washing steps. As described above, purification device controller 98 controls valve 112 and power supply 60 so that reforming liquid L2 temporarily interposed in buffer tub 90 from discharge portion 17 and then is supplied into washing tub 110.

### Operation

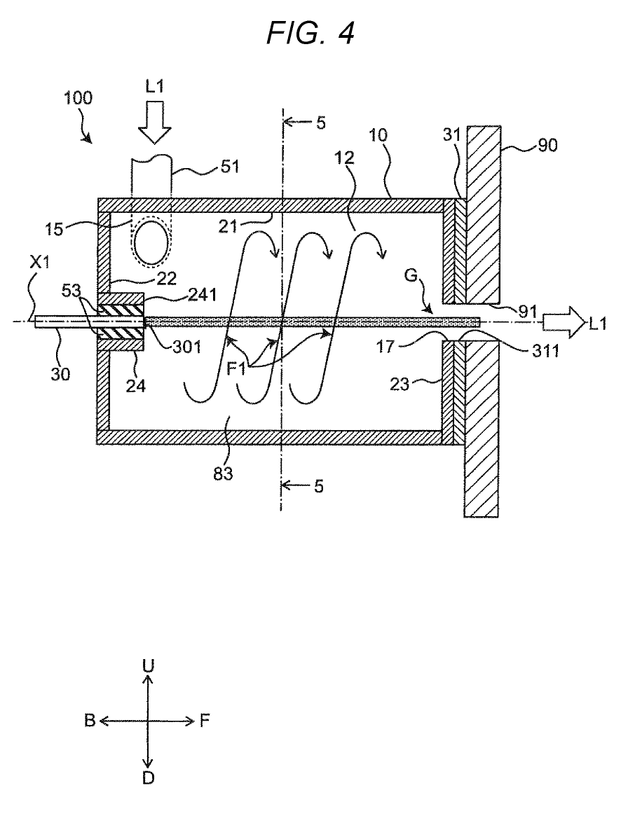

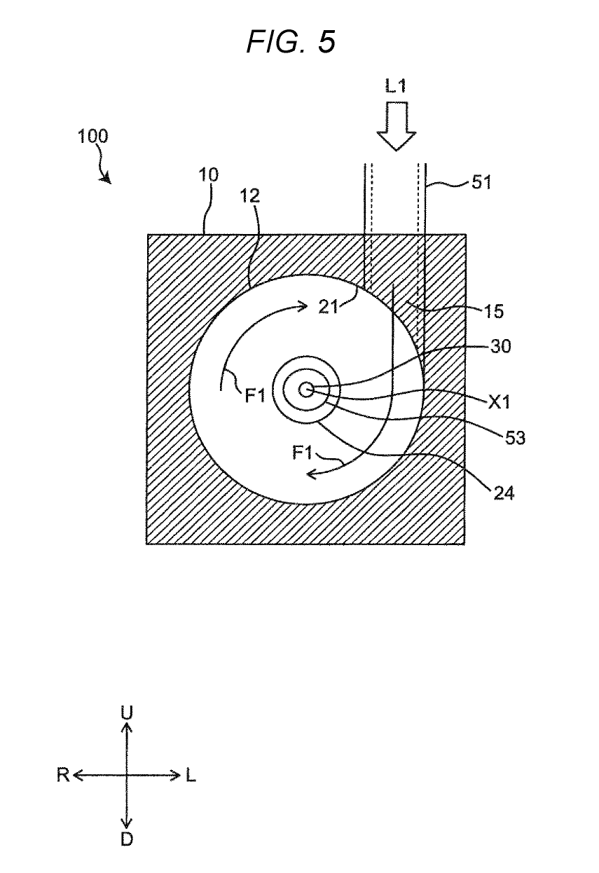

Next, an operation of reforming liquid producing device 100 will be described. Hereinafter, for the sake of convenience of description, a state where gas phase G is generated inside processing tub 12 (FIGS. 4 and 5) and a state where plasma P is generated by applying a pulse voltage to generated gas phase G (FIGS. 6A and 6B) are described separately. FIG. 4 is a side sectional view illustrating a state where swirling flow F1 is generated on the inside of processing tub 12 and the pulse voltage is not applied.

First, as illustrated in FIG. 4, when processed water L1 is introduced from introduction portion 15 into processing tub 12 at a predetermined pressure, processed water L1 moves from introduction portion 15 to the right side of FIG. 4 while generating swirling flow F1 along first inner wall 21. Swirling flow F1 moving to the right side of FIG. 4 while swirling moves toward discharge portion 17.

A pressure in the vicinity of center axis X1 is lowered to less than or equal to a saturated water vapor pressure and a part of processed water L1 is evaporated to generate vaporized water by swirling flow F1. Therefore, gas phase G is produced in the vicinity of center axis X1. Gas phase G is generated in the vicinity of a swirling center, specifically, from right end portion 301 of first electrode 30 to the vicinity of opening 311 of second electrode 31 along center axis X1. In addition, gas phase G is swirled in the same direction as that of swirling flow F1 by coming into contact with swirling flow F1. Swirling gas phase G is sheared by the micro-bubbles or nano-bubbles by receiving resistance of water in buffer tub 90 in the vicinity of discharge portion 17, and is diffused into buffer tub 90.

FIG. 5 is a sectional view which is taken along line 5-5 of FIG. 4. As described in FIG. 4, when processed water L1 is introduced from introduction portion 15 into processing tub 12 at a predetermined pressure, processed water L1 generates swirling flow F1 clockwise in FIG. 5 along first inner wall 21. Processed water L1 is swirled on the inside of processing tub 12 and thereby a pressure in the vicinity of the center of swirling flow F1, that is, in the vicinity of center axis X1 is lowered less than or equal to the saturated water vapor pressure and water vapor which is obtained by evaporating a part of processed water L1 is generated in the vicinity of center axis X1, thereby producing gas phase G.

FIGS. 6A and 6B are side sectional views illustrating a state where swirling flow F1 is generated on the inside of processing tub 12 and the pulse voltage is applied. As illustrated in FIG. 6A, in a state where gas phase G evaporated from processed water L1 is generated from the vicinity of first electrode 30 to the vicinity of second electrode 31, the pulse voltage of a high voltage is applied between first electrode 30 and second electrode 31 by power supply 60. FIG. 6B is an enlarged view of a state where plasma P is generated in gas phase G. When the pulse voltage of a high voltage is applied between first electrode 30 and second electrode 31, plasma P is generated in gas phase G and a radical (OH radical or the like), a compound (hydrogen peroxide or the like), or ions which is water-derived as the reforming component is produced. Gas phase G containing the reforming component is swirled in the same direction as that of swirling flow F1 by swirling flow F1 in a periphery. Gas phase G containing the reforming component is swirled and thereby a part of the reforming component is dissolved into a swirling flow F1. Therefore, the reforming component is dispersed in processed water L1. In addition, gas phase G containing the reforming component in the vicinity of discharge portion 17 is sheared by receiving the resistance of processed water L1 in buffer tub 90 and bubble BA containing the reforming component is generated. In addition, air is prevented from mixing into gas phase G which is in a negative pressure by keeping the reforming liquid in buffer tub 90. As described above, in a state where the reforming component produced by plasma P is bubbled or is dissolved in processed water L1, reforming liquid L2 dispersed in processed water L1 is retained in buffer tub 90 to sterilize processed water L1, that is, washing water 92 in buffer tub 90.

According to Embodiment 1 described above, processed water L1 in swirling flow F1 is evaporated and the pulse voltage is applied to produced gas phase G to generate plasma P. Therefore, gas phase G is at a negative pressure less than a gas phase formed by gas evaporated by Joule heat or gas introduced from the outside, and plasma P can be generated with a small voltage. Therefore, processed water L1 can be efficiently reformed. Furthermore, since water is not evaporated by Joule heat, the energy to be inputted is reduced. In addition, since gas is not introduced from the outside, a gas supply device is not necessary and the reforming liquid producing device can be easily downsized.

In addition, gas phase G that is formed by gas evaporated by Joule heat or gas introduced from the outside is difficult to be held in a certain shape or at a fixed position by buoyancy. However, in gas phase G of Embodiment 1, since a force is applied in a direction of gathering on center axis X1 by surrounding swirling flow F1, constant gas phase G can be produced in the vicinity of right end portion 301 of first electrode 30. Therefore, an amount of gas produced between first electrode 30 and second electrode 31 varies little over time and electric power required for plasma P hardly changes. Therefore, plasma P can be stably generated and processed water L1 can be efficiently reformed.

In addition, a volume of plasma P is less than or equal to a volume of the gas phase in the vicinity of the cathode electrode. Since a shape of gas phase G that is formed by gas evaporated by Joule heat or gas introduced from the outside is a bubble shape, the shape of gas phase G splits when the volume is greater than or equal to a certain volume. Therefore, it is difficult to generate plasma P greater than or equal to a certain volume. However, in the gas phase G of Embodiment 1, if a swirling speed of swirling flow F1 can be secured, a volume in the direction of center axis X1 can be easily increased, so that the volume of plasma P can be easily increased. Therefore, the amount of the reforming component produced is easily increased and water can be rapidly reformed.

In addition, since the volume expands when the liquid evaporates, cavitation, which generates a shock wave and destroys a surrounding object, is known. In Embodiment 1, a position at which the destruction by cavitation is most intensified is at discharge portion 17. At that position, the inner diameter of processing tub 12 is the smallest and the swirling speed of swirling flow F1 is the fastest. Therefore, since right end portion 301 of first electrode 30 in gas phase G is far from a position at which the destruction of the cavitation is the strongest, the interference on first electrode 30 due to the cavitation becomes small and plasma P can be stability generated.

In addition, since processing of processed water L1 is performed without introducing air from the outside, production of harmful nitrous acid which is generated in plasma utilizing a gas phase introducing gas containing a nitrogen component of air or the like can be suppressed. Furthermore, reforming liquid L2 containing bubble BA containing the OH radical, hydrogen peroxide, or the like can be produced.

Reforming liquid producing device 100 functions as the washing machine rinse water purification device. In washing apparatus 101 having a configuration in which buffer tub 90 of reforming liquid producing device 100 is disposed in the vicinity of washing tub 110, a state where washing water 92 is sterilized is illustrated in FIG. 6C and the entire washing apparatus 101 is illustrated in FIG. 6D.

In FIG. 6D, the rinse water for rinsing such as tap water is supplied as processed water L1 from introduction portion 15 into processing tub 12 via pipe 51, pump 50a, and valve 112, or pipe 51 and valve 112. The reforming liquid discharged from processing tub 12 via discharge portion 17 is introduced into buffer tub 90.

An operation as washing apparatus 101 including reforming liquid producing device 100 will be described below. The following example is a case where the reforming liquid is used as the washing rinse water. In a case where the reforming liquid is used as the washing water in a washing step, a washing water introducing signal is inputted instead of the washing rinse water introducing signal. In a case where the reforming liquid is used as the tub washing water in a tub washing step, when a tub washing water introducing signal is inputted instead of the washing rinse water introducing signal, the tub washing water introducing signal is merely read.

If a washing operation is performed in washing tub 110 under the control of washing machine controller 111, when it becomes the rinsing step, that is, the washing rinse water introducing period in a series of washing steps, the washing rinse water introducing signal is inputted from washing machine controller 111 into purification device controller 98. When the washing rinse water introducing signal from washing machine controller 111 of washing tub 110 is received, as described below, purification device controller 98 opens valve 112 and turns on power supply 60 to produce the reforming liquid.

First, valve 112 is opened under the control of purification device controller 98 and in a case of pump 50a, tap water having no pump 50a, or the like, the rinse water such as the tap water is introduced into processing tub 12 of reforming liquid producing device 100 through introduction portion 15 of processing tub 12 as processed water L1 at a supply pressure of the tap water.

Next, swirling flow F1 of processed water L1 is generated in processing tub 12 to produce gas phase G on center axis X1.

Next, power supply 60 is turned on and the pulse voltage is applied to gas phase G under the control of purification device controller 98 to generate plasma P in gas phase G.

Next, active species such as the OH radical is produced in gas phase G by plasma P to generate gas phase G containing the active species such as the OH radical in processing tub 12.

Next, gas phase G containing the active species such as the OH radical is introduced from processing tub 12 via discharge portion 17 to sterilize washing water 92 in buffer tub 90.

Washing water 92 that is sterilized in buffer tub 90 is discharged from reforming liquid discharge port 90b of buffer chamber 90c to rinse port 110b of washing tub 110 at a position higher than discharge portion 17 and is used as the second liquid used in the washing tub, that is, washing water 110a such as the rinse water in washing tub 110.

According to Embodiment 1, processed water L1 of the liquid introduced via introduction portion 15 is swirled from introduction portion 15 to discharge portion 17 to generate swirling flow F1, and plasma P is generated in gas phase G that is produced in swirling flow F1 of processed water L1 to produce the reforming component. The produced reforming component is dissolved in processed water L1 and is dispersed in processed water L1 to produce the reforming liquid. The produced reforming liquid is supplied from discharge portion 17 into buffer tub 90 to sterilize washing water 92 in buffer tub 90. Therefore, washing water 92 can be efficiently sterilized. Here, processed water L1, that is, washing water 92 is evaporated in the swirling flow and the pulse voltage is applied to produced gas phase G to generate plasma P. Since it is necessary to evaporate processed water L1 by applying a voltage, plasma P can be generated, reformation of washing water 92 can be performed efficiently and rapidly with less electric power. That is, washing water 92 can be rapidly reformed and the processing time of washing water 92 can be shortened by efficiently generating plasma P. Therefore, as the reforming liquid, washing water 92, for example, the rinse water can be directly sterilized, which is efficient.

### Modification Examples

The configuration of reforming liquid producing device 100 described in Embodiment 1 is an example and various changes can be provided. For example, the internal structure of processing tub 12, the position of first electrode 30 or second electrode 31, or the like is not limited to the structure of Embodiment 1.

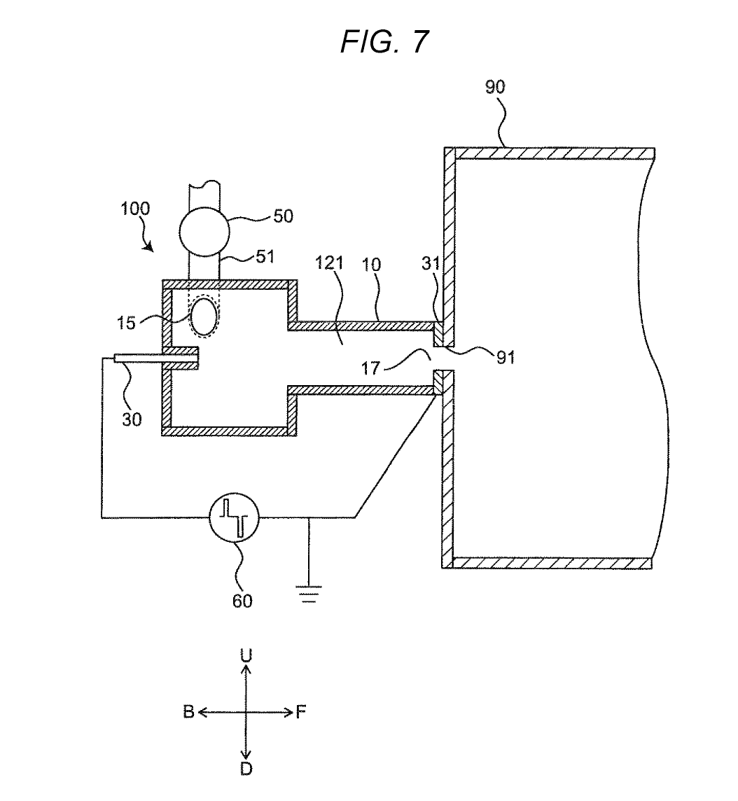

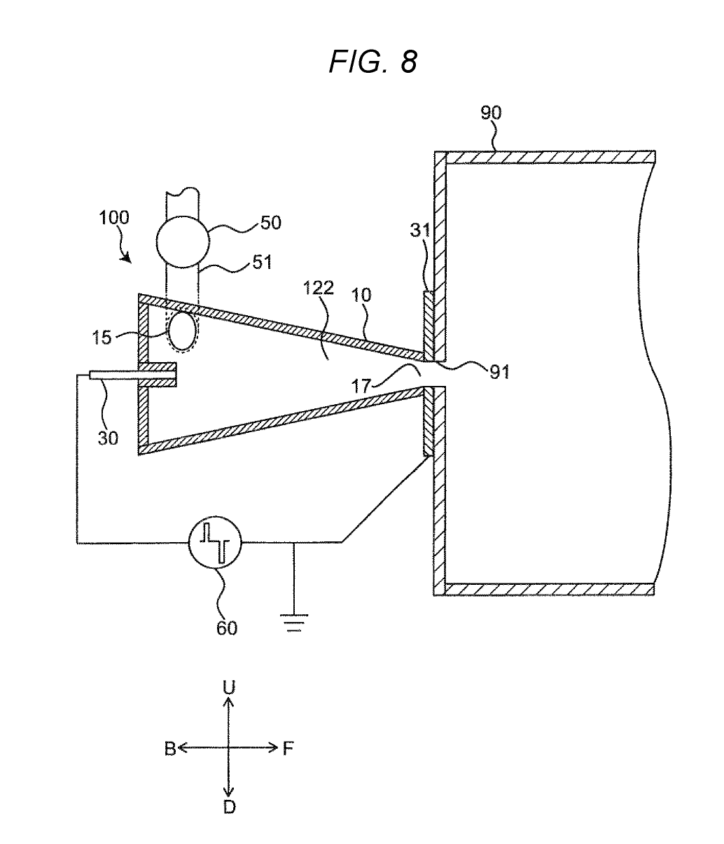

In Embodiment 1, processing tub 12 has a simple cylindrical shape, but as long as it is a cylindrical processing tub having a circular cross-sectional shape and a narrowed and hole-shaped discharge portion is provided on the center axis or in the vicinity of the center axis of the processing tub at one end portion of the processing tub, various shapes can be provided. For example, as illustrated in FIG. 7, the same effect can be obtained even in processing tub 121 combining cylinders having different radii. In FIG. 7, a radius on the introduction portion side is larger than a radius on the discharge portion side. Alternatively, the same effect can be obtained even in conical shaped processing tub 122 illustrated in FIG. 8. Preferably, in order to prevent swirling flow F1 from sliding in the forward direction F, as illustrated in FIG. 8, the conical shape of which an inner diameter of a cross-section continuously decreases is preferable.

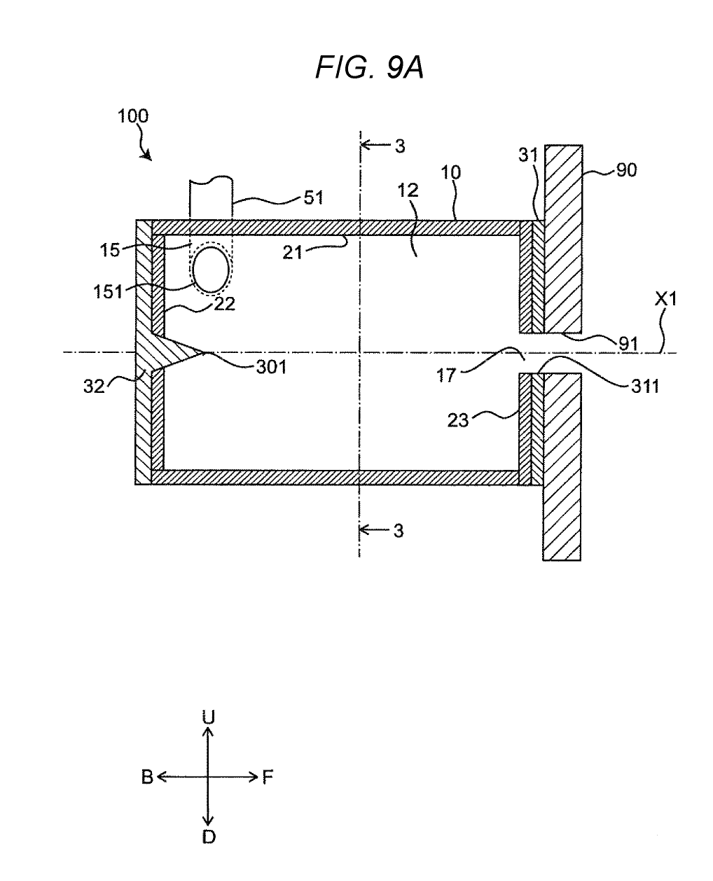

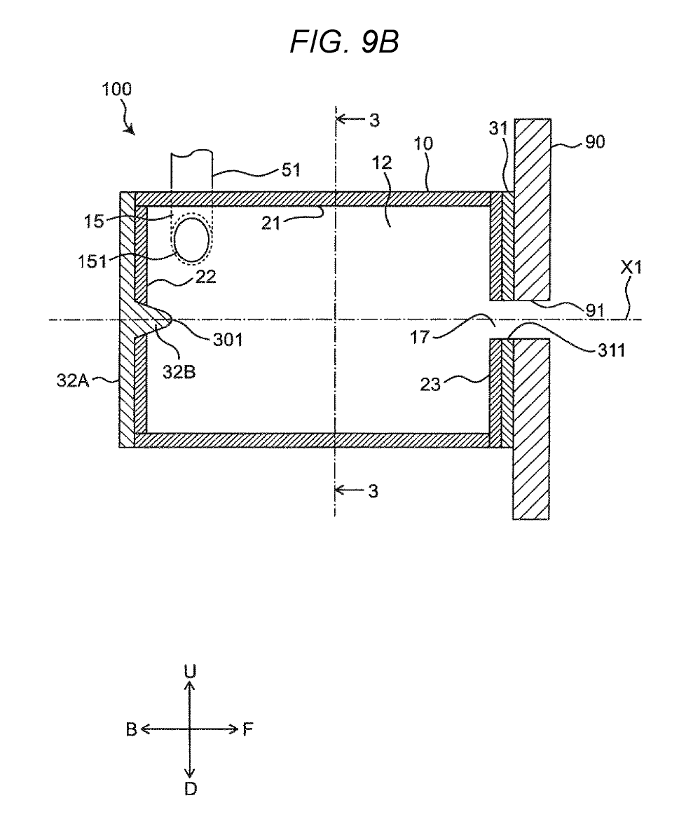

In addition, in Embodiment 1, the shape of first electrode 30 is a rod shape, but it is not limited to the embodiment as long as first electrode 30 has a shape in which electrolysis is concentrated on the right end portion 301 of first electrode 30. For example, as illustrated in FIG. 9A, plate-like first electrode 32 having a conical shape pointed toward the discharge portion side may be provided. In addition, as illustrated in FIG. 9B, instead of the conical shape, plate-like first electrode 32A having a mountain-shaped protrusion 32B protruding so as to curve toward the discharge portion side may be provided. In first electrode 32A, a center portion closest to generated plasma P tends to wear out, so that it is preferable that the electrode having mountain-shaped protrusion 32B of which the center portion protrudes inward toward the processing tub 12 has a longer life than that of a simple flat electrode. More preferably, instead of plate-like first electrode 32, when the electrode is worn, a rod electrode, which facilitates delivery of an electrode inside processing tub 12, may be provided.

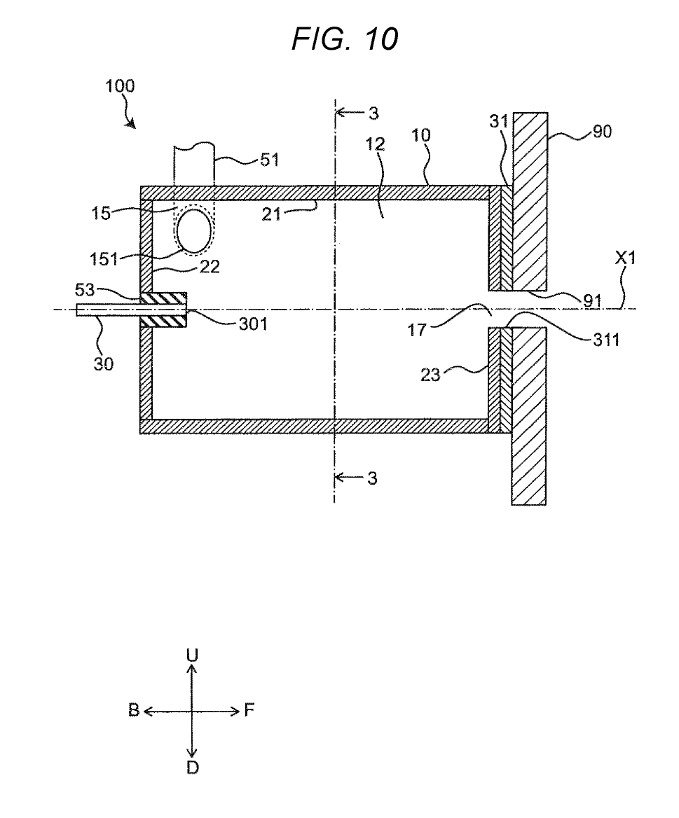

In addition, as illustrated in FIG. 10, the same effect can be obtained by adopting a structure in which first electrode 30 and insulator 53 are attached to second inner wall 22 without using electrode support tube 24 of first electrode 30. Preferably, in order to suppress the electrolysis of water or the generation of Joule heat, an insulator may be covered except for a connecting portion between right end portion 301 of first electrode 30 which is necessary for generating plasma and power supply 60.

In addition, in Embodiment 1, the material of first electrode 30 is tungsten as an example, but it is not limited to the embodiment as long as it is a material particularly having conductivity. Preferably, a metal material capable of exhibiting a high sterilization effect by causing a Fenton reaction when the metal material is in contact with hydrogen peroxide in water may be provided. For example, stainless steel (SUS), copper, or copper tungsten is preferable.

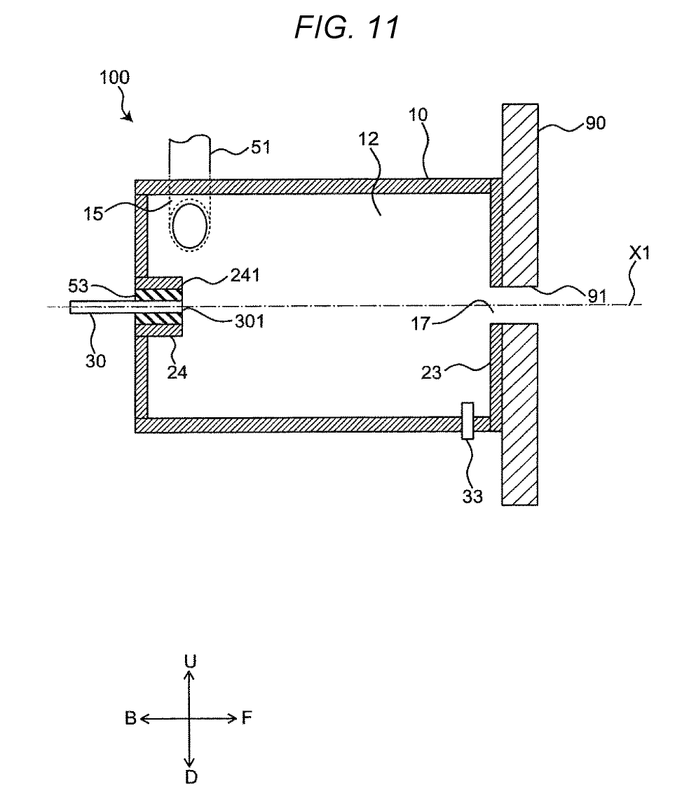

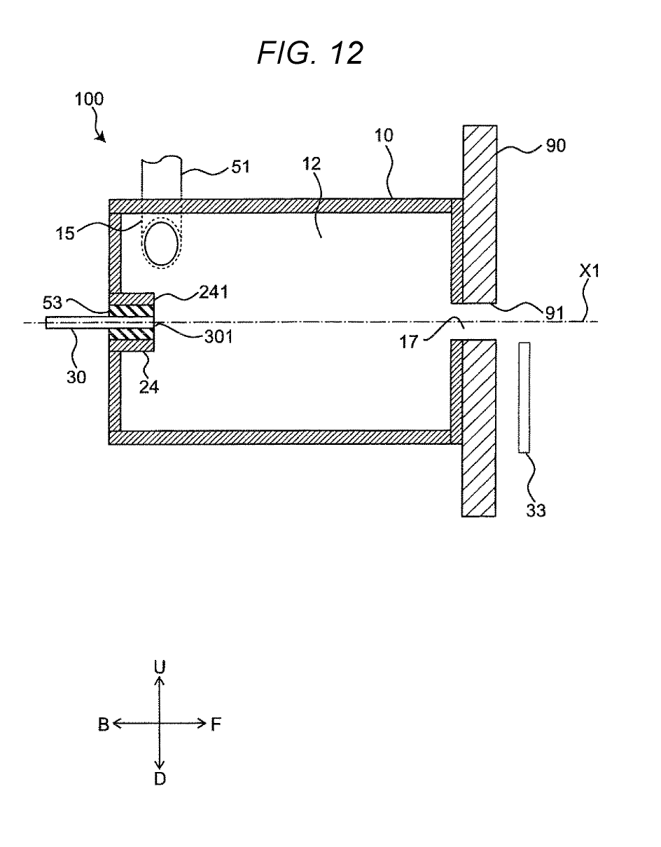

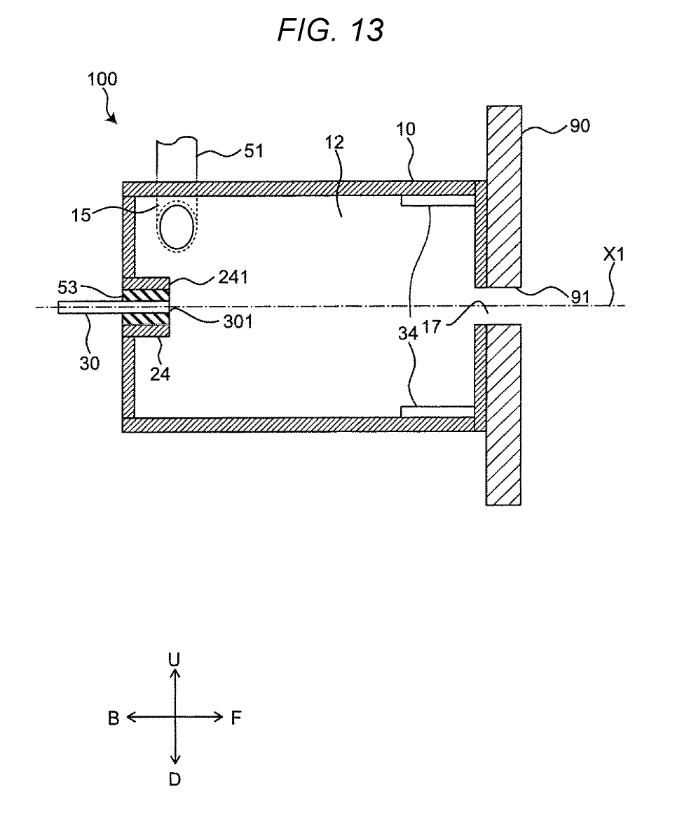

In Embodiment 1, second electrode 31 is disposed at discharge portion 17, but it is not limited to the embodiment as long as at least a part of the grounded second electrode is disposed inside processing tub 12. For example, as for the disposition location, as illustrated in FIG. 11, the same effect can be obtained even if rod-like second electrode 33 is disposed on one side of first inner wall 21 in center axis X1. In addition, as illustrated in FIG. 12, rod-like second electrode 33 may be disposed outside processing tub 12, inside buffer tub 90, and in the vicinity of intake port 91 of buffer tub 90. In addition, as illustrated in FIG. 13, cylindrical second electrode 34 may be disposed inside first inner wall 21. In addition, opening 311 has a cylindrical shape, but it may be a polygonal shape, or the second electrode may be formed by combining a plurality of divided metal members. Preferably, in order not to disturb swirling flow F1, a plate shape or a cylindrical shape having a round hole may be provided. In addition, the shorter the distance between gas phase G and the second electrode is, the smaller the resistance of water is, thus Joule heat can be suppressed. Therefore, it is preferable that the second electrode is disposed at discharge portion 17 or in the vicinity of discharge portion 17 at which the distance between gas phase G and the second electrode is short.

A flow rate of processed water L1 introduced into processing tub 12 is set to a flow rate at which gas phase G is generated in swirling flow F1 according to the shape of processing tub 12. In addition, the pulse voltage applied to first electrode 30 and second electrode 31 may be monopolar instead of bipolar, or a voltage, a pulse width, a frequency, or the like may be appropriately set to a value at which plasma P can be generated in gas phase G generated in swirling flow F1.

Furthermore, power supply 60 may be a high-frequency power supply or the like other than a pulse power supply as long as the effect of the disclosure can be obtained. Preferably, since the pH between electrodes is biased due to the electrolysis of water, bipolar application may be provided so that the cathode and the anode can be alternately exchanged.

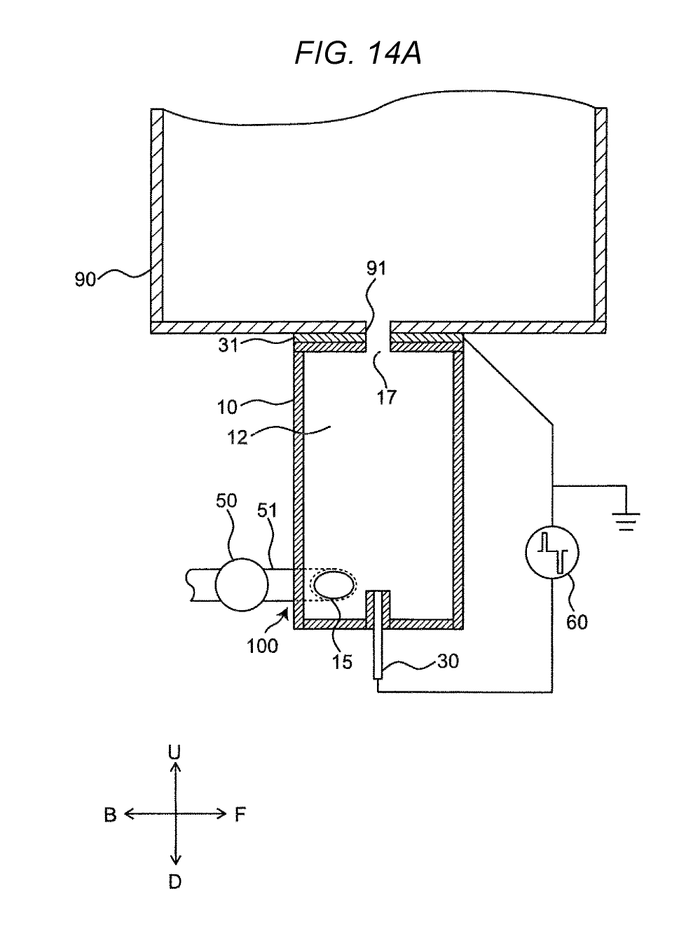

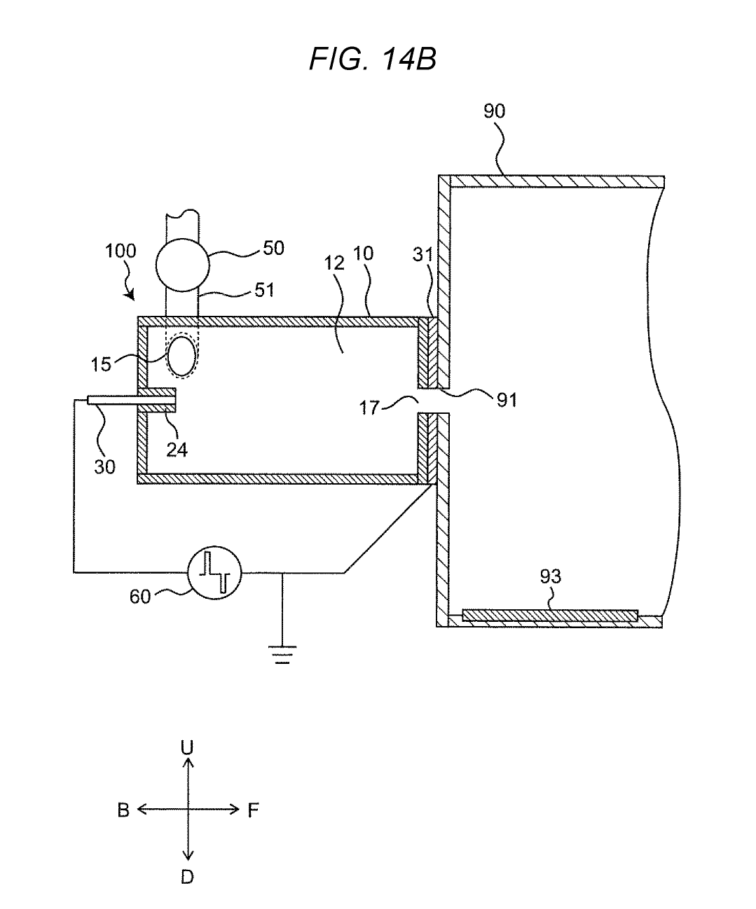

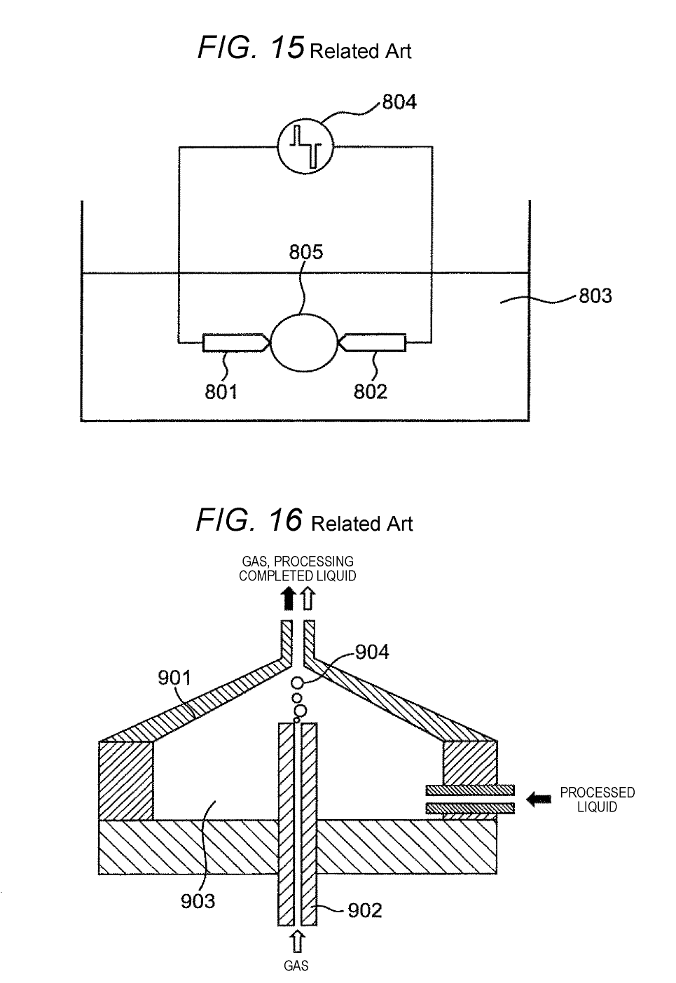

Buffer tub 90 is a tub shape, but it is not limited to the tub shape as long as the shape in which the washing water can be held in buffer tub 90 is provided in order to shear swirling flow F1. Preferably, in order to fill discharge portion 17 with processed water L1 and prevent air from entering processing tub 12, as illustrated in FIG. 14A, device body 10 discharges the reforming liquid upward and buffer tub 90 may be on the upper side of device body 10.

In addition, as a material configuring buffer tub 90, it is sufficient that water does not permeate. In addition, for example, as illustrated in FIG. 14B, plate member 93 containing copper or iron capable of exhibiting a high sterilization effect by causing the Fenton reaction with hydrogen peroxide water which is one of the reforming components can be used for a part of or all buffer tub 90. In addition, plate member 93 may be disposed in buffer tub 90 as a member separated from buffer tub 90. In short, when plate member 93 comes into contact with the reforming liquid in buffer tub 90, a high sterilization effect due to the Fenton reaction with hydrogen peroxide water which is one of the reforming components can be exhibited.

In addition, copper or iron nano-particles are produced by plasma P. The Fenton reaction with hydrogen peroxide and processing can be accelerated by using a first electrode 30 containing a copper or iron component as the material of first electrode 30.

Although Embodiment 1 and the modification examples of the disclosure are described above, Embodiment 1 and the modification examples described above are merely examples for implementing the disclosure. Therefore, the disclosure is not limited to Embodiment 1 and the modification examples described above. Embodiment 1 and the modification examples described above can be appropriately modified and implemented without departing from the spirit of the disclosure.

That is, it is possible to achieve each of the effects provided therein by appropriately combining arbitrary embodiment or a modification example of the embodiment or the various modification examples described above. In addition, a combination of the embodiments, a combination of the examples, or a combination of the embodiments and the examples is possible and a combination of features in different embodiments or examples is also possible.

The washing machine rinse water purification device and the washing apparatus according to the aspects of the disclosure can be applied to perform sterilization processing of the water for washing such as the washing rinse water, the washing water, or the tub washing water of the washing tub, are useful for use as the water for washing, and can also be applied to the rinse water of a dish washer or the like.

What is claimed is:

1. A washing machine rinse water purification device comprising:
a processing tub that generates a gas phase in a vicinity of a swirling center of a swirling flow of a first liquid by swirling the first liquid introduced from an introduction portion around a center axis and includes a discharge portion that discharges the first liquid;
a buffer tub that includes a buffer chamber which temporarily stores the first liquid discharged from the discharge portion of the processing tub and a reforming liquid discharge port of the buffer chamber connectable to a rinse port of a washing tub at a position higher than the discharge portion, and supplies the first liquid temporarily stored in the buffer chamber from the reforming liquid discharge port to the rinse port of the washing tub as a second liquid to be used in the washing tub;
a first liquid supplier that introduces the first liquid from the introduction portion into the processing tub;
a first electrode of which at least a part is disposed in the processing tub on one end side along the center axis of the processing tub to come into contact with the first liquid in the processing tub;
a second electrode that is disposed so as to come into contact with the first liquid in the processing tub on an other end side along the center axis of the processing tub; and
a power supply that generates plasma in the gas phase by applying a voltage between the first electrode and the second electrode,
wherein the first liquid introduced from the introduction portion in the first liquid supplier into the processing tub is swirled between the introduction portion and the discharge portion to generate the swirling flow, the plasma is generated in the gas phase to produce a reforming component, the produced reforming component is dissolved in the first liquid and is dispersed in the first liquid to produce a reforming liquid, and the produced reforming liquid temporarily passes through the buffer tub from the discharge portion and then is supplied into the washing tub as the second liquid.

2. The washing machine rinse water purification device of claim 1, further comprising:
a controller that controls the first liquid supplier so that the reforming liquid once passes through the buffer tub from the discharge portion and then is supplied into the washing tub as the second liquid to be used in the washing tub during a period of introducing washing rinse water in the washing tub.

3. The washing machine rinse water purification device of claim 1,
wherein the first electrode is disposed so as to come into contact with the gas phase generated in the vicinity of the swirling center of the swirling flow of the first liquid or be positioned in a vicinity of the gas phase.

4. The washing machine rinse water purification device of claim 1,
wherein the processing tub includes a cylindrical or truncated conical first inner wall that generates the swirling flow by swirling the first liquid supplied from the introduction portion, and
wherein the first electrode is disposed on a center axis of the first inner wall that is the center axis of the processing tub or in a vicinity of the center axis.

5. The washing machine rinse water purification device of claim 4,
wherein the first electrode is disposed on one end portion side of the center axis or the vicinity of the center axis,
wherein the second electrode is disposed on an other end portion side of the center axis or the vicinity of the center axis,
wherein the introduction portion is disposed on the one end portion side of the center axis, and
wherein the discharge portion is disposed on the other end portion side of the center axis.

6. The washing machine rinse water purification device of claim 5,
wherein the second electrode is a plate-like electrode that is disposed so as to surround a part around the center axis of the first inner wall on an other end portion side of the first inner wall or an entire circumference of the center axis.

7. The washing machine rinse water purification device of claim 5,
wherein the second electrode is disposed on a side of the center axis of the first inner wall on an other end portion side of the first inner wall.

8. The washing machine rinse water purification device of claim 5,
wherein the second electrode is a cylindrical electrode that is disposed so as to surround a part of the center axis of the first inner wall on the other end portion side of the first inner wall or an entire circumference of the center axis.

9. The washing machine rinse water purification device of claim 1,
wherein the processing tub includes a columnar processing chamber having a circular cross-section closed at one end side of the processing tub along a swirling axis of the first liquid, and
wherein the first liquid supplier introduces a washing rinse water from the introduction portion into the processing tub in a tangential direction of the columnar processing chamber of the processing tub.

10. A washing apparatus comprising:
the washing machine rinse water purification device of claim 1,
wherein the washing tub to which the reforming liquid generated in the washing machine rinse water purification device is supplied from the buffer tub via the rinse port as the second liquid.

11. A washing apparatus comprising:
the washing machine rinse water purification device of claim 2,
wherein the washing tub to which the reforming liquid generated in the washing machine rinse water purification device is supplied from the buffer tub via the rinse port as the second liquid.

12. A washing apparatus comprising:
the washing machine rinse water purification device of claim 3,
wherein the washing tub to which the reforming liquid generated in the washing machine rinse water purification device is supplied from the buffer tub via the rinse port as the second liquid.

13. A washing apparatus comprising:
the washing machine rinse water purification device of claim 4,
wherein the washing tub to which the reforming liquid generated in the washing machine rinse water purification device is supplied from the buffer tub via the rinse port as the second liquid.

14. A washing apparatus comprising:
the washing machine rinse water purification device of claim 5,
wherein the washing tub to which the reforming liquid generated in the washing machine rinse water purification device is supplied from the buffer tub via the rinse port as the second liquid.

15. A washing apparatus comprising:
the washing machine rinse water purification device of claim 6,
wherein the washing tub to which the reforming liquid generated in the washing machine rinse water purification device is supplied from the buffer tub via the rinse port as the second liquid.

16. A washing apparatus comprising:
the washing machine rinse water purification device of claim 7,
wherein the washing tub to which the reforming liquid generated in the washing machine rinse water purification device is supplied from the buffer tub via the rinse port as the second liquid.

17. A washing apparatus comprising:
the washing machine rinse water purification device of claim 8,
wherein the washing tub to which the reforming liquid generated in the washing machine rinse water purification device is supplied from the buffer tub via the rinse port as the second liquid.

18. A washing apparatus comprising:
the washing machine rinse water purification device of claim 9,
wherein the washing tub to which the reforming liquid generated in the washing machine rinse water purification device is supplied from the buffer tub via the rinse port as the second liquid.

19. The washing machine rinse water purification device of claim 1,
wherein a material of the first electrode includes stainless steel, copper, copper tungsten or tungsten.
